(19) United States
(12) Patent Application Publication
(10) Pub. No.: US 2007/0290653 A1
(43) Pub. Date: Dec. 20, 2007

(54) Buttonless Battery Charger Interface

(75) Inventor: Randolph A. Ibrahim, Sedalia, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electritek-AVT, Inc., Littleton, CO (US)

(21) Appl. No.: 11/766,031

(22) Filed: Jun. 20, 2007

Related U.S. Application Data
(63) Continuation-in-part of application No. 11/326,765, filed on Jan. 6, 2006.
(60) Provisional application No. 60/642,211, filed on Jan. 6, 2005.

(51) Int. Cl. H02J 7/00

(52) U.S. Cl. 320/107; 320/137

(57) ABSTRACT

According to the invention, a battery charging apparatus with a plurality of modes for charging a battery is disclosed. The apparatus may have a battery receptacle and a command processor. The battery receptacle may be adapted to detachably and mechanically couple with the battery and may be adapted to detachably and electrically couple the battery with a battery charging circuit. The command processor may be configured to: detect a first at least partial mechanical coupling of the battery with the battery receptacle; detect a first at least partial mechanical decoupling of the battery from the battery receptacle; detect a first at least partial mechanical recoupling of the battery with the battery receptacle; and/or to communicate a first instruction to the battery charging circuit based at least in part on detecting the first at least partial mechanical recoupling within a particular time period after the first at least partial mechanical decoupling.

### CROSS-REFERENCES TO RELATED APPLICATIONS

This application is a continuation-in-part of U.S. patent application Ser. No. 11/326,765 filed Jan. 6, 2006, entitled “Discharge Circuit,” the entire disclosure of which is hereby incorporated by reference as if fully set forth herein.

U.S. patent application Ser. No. 11/326,765 claims priority to Provisional U.S. Patent Application No. 60/642,211, filed Jan. 6, 2005, entitled “Charging System,” the entire disclosure of which is hereby incorporated by reference as if fully set forth herein.

### BACKGROUND OF THE INVENTION

Battery chargers and other devices which use and charge both “smart” batteries and “dumb” batteries often have to operate in a wide range of environments, and are often used by operators with a wide range of experience with such devices. Environments may range from harsh environments in extremely critical operating environments, such as military combat environments, to relatively clean environments and low priority uses as is typical with the common consumer.

Even battery chargers for “dumb” batteries may have a number of controls, for example, buttons and switches, to direct operation of the charger. Battery chargers for “smart” batteries, which may have microcontrollers to manage charge, discharge, calibration, and end-of-life for the battery, may have even more complex control mechanisms. The interfaces for these chargers, which may sometimes reside on the battery itself, may have an increasing number of controls to manage the multiple different modes of operation.

Environmental factors may cause even the most simple of the above control mechanisms to fail under normal and heavy use, much less the more complicated mechanisms. In addition, the more options available to the user through the control mechanism, the more likely confusion may be caused in users who are either inexperienced, in a hurry, or under stressful conditions when using the device.

### BRIEF DESCRIPTION OF THE DRAWINGS

FIG. 1 is a block diagram of a battery and a battery charging apparatus having a battery receptacle, charging circuit and command processor.

FIG. 2 is a block diagram, similar to the block diagram shown in FIG. 1, except showing one possible configuration of connections within the battery charging apparatus.

FIG. 3 is a block diagram, similar to the block diagram shown in FIG. 2, except where the functions of the discharge circuit are performed by a charging sub-circuit and a discharge sub-circuit.

FIG. 4 is a block diagram, similar to the block diagram shown in FIG. 3, except showing relay switches within the charging sub-circuit and discharge sub-circuit controlled by the command processor.

FIG. 5 is a block diagram, similar to the block diagram shown in FIG. 4, except having a separate electrical circuit to detect mechanical coupling.

FIG. 6 is a block diagram, similar to the block diagram shown in FIG. 5, except having a mechanical switch instead of the separate electrical circuit to detect mechanical coupling.

FIG. 7 is a block diagram, similar to the block diagram shown in FIG. 6, except having an indicator array to inform the user of the battery charging apparatus status.

FIG. 8 is a block diagram, similar to the block diagram shown in FIG. 7, except having an indicator array on the battery instead of the battery charging apparatus.

FIG. 9 is a flow diagram of a method for communicating either of two possible instructions to an electrical apparatus.

FIG. 10 is a flow diagram of a method, similar to the method in FIG. 9, except which also uses determined characteristics of a battery to prioritize instructions.

FIG. 11 is a flow diagram of a method, similar to the method in FIG. 10, except also capable of communicating a third possible instruction.

FIG. 12 is a flow diagram of a method, similar to the method in FIG. 11, except also capable of communicating a fourth possible instruction.

FIG. 13 is a flow diagram of a method, similar to the method in FIG. 12, which also informs a user of which instruction is communicated.

FIG. 14 is a block diagram of an exemplary computer system capable of being used in at least some portion of the apparatuses of the present invention, or implementing at least some portion of the methods of the present invention.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter suffix.

### DETAILED DESCRIPTION OF THE PREFERRED EMBODIMENTS

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a battery charging apparatus with a plurality of modes for charging a battery is described. The battery charging apparatus may be any electrical apparatus. Merely by way of example, the battery charging apparatus may be a mobile or stationary battery charger, either consumer, commercial, or industrial; an audio and/or visual device such as a video recorder or portable audio player, a communication device, such as a mobile telephone or two-way radio, lighting device, such as a flashlight or portable spotlight; and/or portable computing devices such as laptop and notebook computers.

The battery charging apparatus may include a battery receptacle and a command processor. The battery receptacle may be adapted to detachably and mechanically couple with the battery. The battery receptacle may also be adapted to detachably and electrically couple the battery with a battery charging circuit. In some embodiments, the electrical coupling may only occur when the battery is completely mechanically coupled with the battery receptacle. In other embodiments, the electrical coupling may occur when the battery is only partially mechanical coupled with the battery receptacle. In some embodiments, the battery and the battery receptacle may be configured to “rock” in the receptacle. “Rocking” the battery may move the battery between one at least partially mechanically coupled position and another at least partially mechanically coupled position, or even a fully mechanically coupled position. In these or other embodiments then, electrical coupling may be able to be maintained, while the state of the mechanical coupling changes to varying degrees.

The command processor may be configured to detect partial and/or complete mechanical and/or electrical coupling and uncoupling of the battery with the battery receptacle. For example, the command processor may be configured to detect a first at least partial mechanical coupling of the battery with the battery receptacle, a first at least partial mechanical decoupling of the battery from the battery receptacle, and a first at least partial mechanical recoupling of the battery with the battery receptacle.

Detecting whether or not an at least partial mechanical coupling has occurred may be accomplished in any way which detects a change of physical position of the battery. For example, in embodiments where there is not continuous electrical coupling when the battery is in different states of partial mechanical coupling, mere detection of electrical coupling may indicate the battery is in a different position and that the status of the mechanical coupling has changed. In addition, other devices, such as a proximity sensor, a mechanical switch, or a separate electrical circuit which is shorted in different states of mechanical coupling may be used to determine the state of the mechanical coupling.

The command processor may also be configured to communicate instructions to the battery charging circuit based on what partial and/or complete mechanical and/or electrical coupling and uncoupling of the battery with the battery receptacle is detected. For example, the command processor may be configured to communicate a first instruction based at least in part on detecting the first at least partial mechanical recoupling within the particular time period after the first at least partial mechanical decoupling.

In some embodiments, the particular time period may begin at substantially the same point in time as the first at least partial mechanical decoupling is detected. In other embodiments, the particular time period may begin at some point in time after the first at least partial mechanical decoupling is detected. The particular time period may end at some point in time thereafter in either example. In one example then, the time period may begin when the first at least partial mechanical decoupling is detected, and end five seconds thereafter. In a second example, the time period may begin two seconds after the first at least partial mechanical decoupling is detected, and end five seconds thereafter. While five and two seconds are used in these examples, any suitable time period may be used by the command processor.

In another example, the command processor may also be configured to communicate a second instruction to the battery charging circuit based at least in part on detecting the first at least partial mechanical coupling. In yet another example, the command processor may be configured to detect a second at least partial mechanical decoupling of the battery from the battery receptacle and a second at least partial mechanical recoupling of the battery with the battery receptacle. The command processor may then communicate a third instruction to the battery charging circuit based at least in part on detecting the second at least partial mechanical recoupling within a particular time period after the second at least partial mechanical decoupling. The particular time periods discussed here may start and end at varying times, just as discussed above.

Finally, in another example, the command processor may be configured to detect a third at least partial mechanical decoupling of the battery from the battery receptacle, and a third at least partial mechanical recoupling of the battery with the battery receptacle. The command processor may then communicate a fourth instruction to the battery charging circuit based at least in part on detecting the third at least partial mechanical recoupling of the battery within a particular time period after the third at least partial mechanical decoupling.

In the manner thus described, different instructions may be communicated by the command processor to the battery charging circuit depending on the number of times the battery is at least partially mechanically decoupled and recoupled with the battery receptacle.

In some embodiments, one or more of the possible instructions communicated by the command processor may be based at least in part on an automatic determination of at least one characteristic of the battery. For example, the first, second, third and/or fourth instructions discussed above may be based at least in part on an automatic determination of at least one characteristic of the battery. Characteristics of the battery may include, but are not limited to, charge level, voltage, current, number of previous recharges, age, and/or temperature. Characteristics may be automatically determined at the time the battery is coupled with the battery receptacle, or may be previously determined and stored either on the battery or elsewhere and simply referred to when the battery is coupled with the battery receptacle.

In some embodiments the battery charging apparatus may be configured to operate in a plurality of modes. The plurality of modes may include, merely by way of example, a calibration mode, a quick charging mode, a slow charging mode, and a discharge mode. Instructions communicated to the battery charging circuit may include a mode instruction directing the battery charging circuit to operate in at least one or more of a plurality of modes. For example, one possible instruction may be to direct the battery charging circuit to operate in a quick charging mode, while another possible instruction might be to operate in slow charging mode. In another example, an instruction might include two or more mode instructions, for instance, a direction to operate in discharge mode, and once discharge mode is complete, to operate in slow charging mode.

In some embodiments, the battery charging apparatus may also have an indicator configured to inform a user of a last instruction communicated to the battery charging circuit. In some embodiments, the indicator may also, or instead, inform a user of the instruction that will be communicated to the battery charging circuit if another decoupling and/or recoupling does not occur. The above discussed indicator or another indicator may also inform the user of the sequence of operations necessary to send different communications and/or instructions to the battery charging circuit, either at each coupling, or prior to the initial coupling. Thus, the indicator may be at least partially static (i.e. printed written instructions or a single pre-recorded audio instruction), and/or at least partially dynamic (i.e. indicator lights, changing visual displays, and/or changing audio instructions).

Some instructions for the user may be intended to be delivered to the user initially (such as written instructions), while other instructions may inform the user of steps required further into a process of coupling a battery with the battery receptacle. In one example then, the battery charging apparatus may have written instructions informing a user to couple the battery with the charger to begin operation. Once the user has at least partially mechanically coupled the battery with the battery receptacle, the battery charging apparatus may then inform the user of the operation that the command processor has determined to be either the best operation suited to the battery, or an operation the command processor believes it most likely that the user wishes to commence (based on an automatic determination of at least one characteristic of the battery as described above).

The user may also be informed of what activity will instead be commenced if the user at least partially mechanically decouples and recouples the battery with the battery receptacle. The process may then repeat itself, with the battery charging apparatus informing the user of the forthcoming operation, but informing the user of how to alter which operation will commence via another decoupling and recoupling.

In another example, the command processor may have a preset sequence of instructions, and each coupling or recoupling of the battery with the battery receptacle may cause the next sequential instruction to be communicated by the command processor to the battery charging circuit. This sequence of instructions may be printed on an operator-facing side of the battery charging apparatus. In these or any other embodiments, the command processor may wait for a particular amount of time before communicating the instruction to the battery charging circuit. This may insure that the command processor has understood the final intent of the user regarding the instruction to be communicated to the battery charging circuit.

In another embodiment of the invention, a method for communicating one or more instructions to an electrical apparatus with a battery receptacle is described. The method may include a step of detecting a first at least partial mechanical coupling of a battery with the battery receptacle, a step of detecting a first at least partial mechanical decoupling of the battery from the battery receptacle, a step of detecting a first at least partial mechanical recoupling of the battery with the battery receptacle, and a step of communicating a first instruction to the electrical apparatus based at least in part on detecting the first at least partial mechanical recoupling within a particular time period after the first at least partial mechanical decoupling.

In some embodiments, the method may also include a step of communicating a second instruction to the electrical apparatus based at least in part on detecting the first at least partial mechanical coupling. In some embodiments, the method may further include a step of detecting a second at least partial mechanical decoupling of the battery from the battery receptacle, a step of detecting a second at least partial mechanical recoupling of the battery with the battery receptacle, and a step of communicating a third instruction to the electrical apparatus based at least in part on detecting the second at least partial mechanical recoupling within a particular time period after the second at least partial mechanical decoupling.

In these or other embodiments, the method may also include a step of detecting a third at least partial mechanical decoupling of the battery from the battery receptacle, a step of detecting a third at least partial mechanical recoupling of the battery with the battery receptacle, and a step of communicating a fourth instruction to the electrical apparatus based at least in part on detecting the third at least partial mechanical recoupling within a particular time period after the third at least partial mechanical decoupling.

In some embodiments, one or more of the possible instructions communicated to the electrical apparatus may be based at least in part on an automatic determination of at least one characteristic of the battery. For example, the first, second, third and/or fourth instructions discussed above may be based at least in part on an automatic determination of at least one characteristic of the battery.

In some embodiments, the method may also include a step of informing a user of a last instruction communicated to the electrical apparatus.

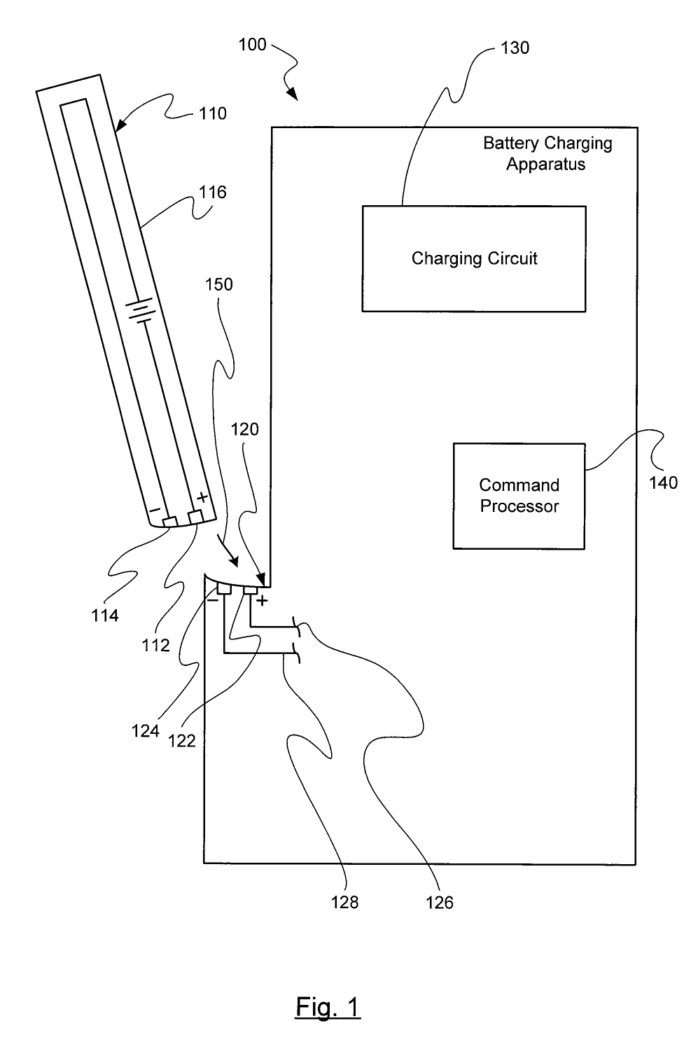

Turning now to FIG. 1, a block diagram of a battery 110 and a battery charging apparatus 100 having a battery receptacle 120, a charging circuit 130, and a command processor 140 is shown. Battery 110 may have a positive terminal 112 and a negative terminal 114, and may also have a casing 116 shaped to be accepted by battery receptacle 120 when it is inserted thereto in a direction generally shown by directional arrow 150.

Battery receptacle 120 also has a positive terminal 122 and a negative terminal 124 configured mate with positive terminal 112 and negative terminal 114 on battery 110 so as to electrically couple battery 110 with battery charging apparatus 100. Leads 126, 128 may couple positive terminal 122 and negative terminal 124 to charging circuit 130, command processor 140, and any other components of battery charging apparatus 100.

In this embodiment, a user may rock battery 110 in battery receptacle 120, thereby coupling, decoupling, and recoupling terminals 112, 114 of battery 110 with terminals 122, 124 of battery charging apparatus 100. Command processor 140 may detect these electrical couplings, decouplings, and recouplings (which also implicitly represent mechanical couplings, decouplings, and recouplings) and communicate instructions to charging circuit 130. Charging circuit 130 may be coupled with leads 126, 128 and perform operations on battery 110 per instructions contained within communications from command processor 140. Note that while command processor 140 and charging circuit 130 are shown as two components in this embodiment, other embodiments may combine the functions of both into a single component. In other embodiments, such as those which will be discussed below, individual functions of either charging circuit 130 and/or the command processor 140 may be handled by additional sub-components.

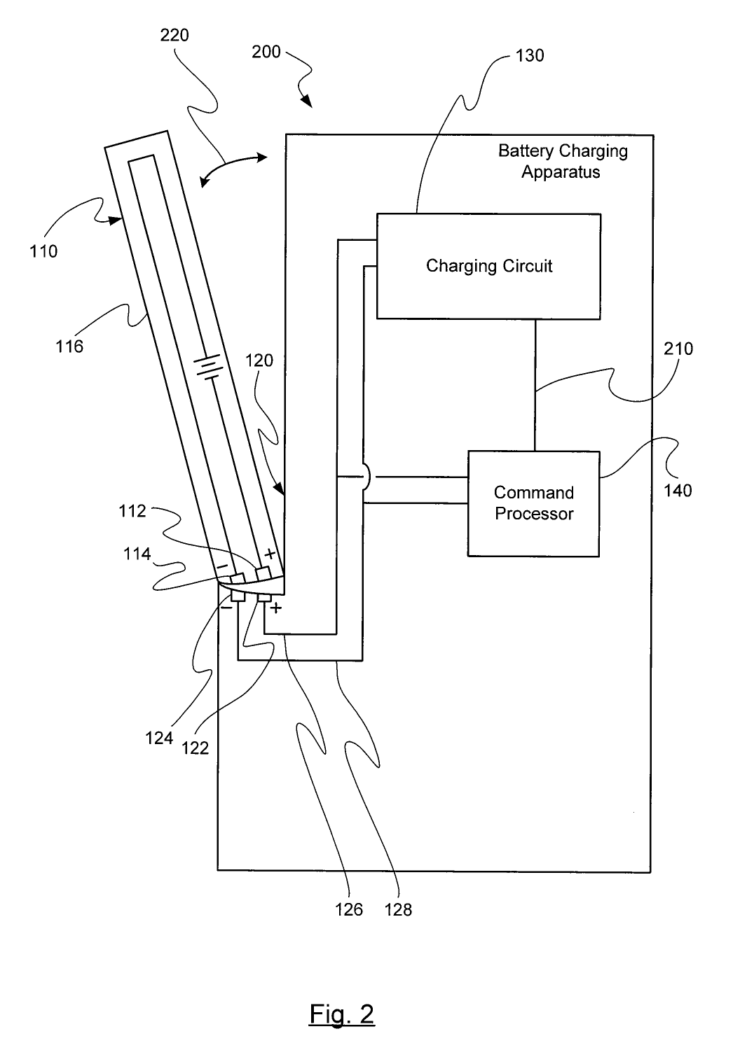

FIG. 2 is a block diagram, similar to the block diagram shown in FIG. 1, except showing one possible configuration of connections within battery charging apparatus 200. In this embodiment, leads 126, 128 are shown coupled with both charging circuit 130 and command processor 140. Command processor 140 may detect couplings, decouplings, and recouplings of battery 110 via leads 126, 128, and charging circuit 130 may perform operations on battery 110 via leads 126, 128. Communications from command processor 140 to charging circuit 130 may be transmitted via communication connection 210.

Also, in this embodiment, battery 110 is shown in an at least partially mechanically coupled state with battery receptacle 120. Directional arrow 220 shows how battery 110 may be rocked back-and-forth in battery receptacle 120.

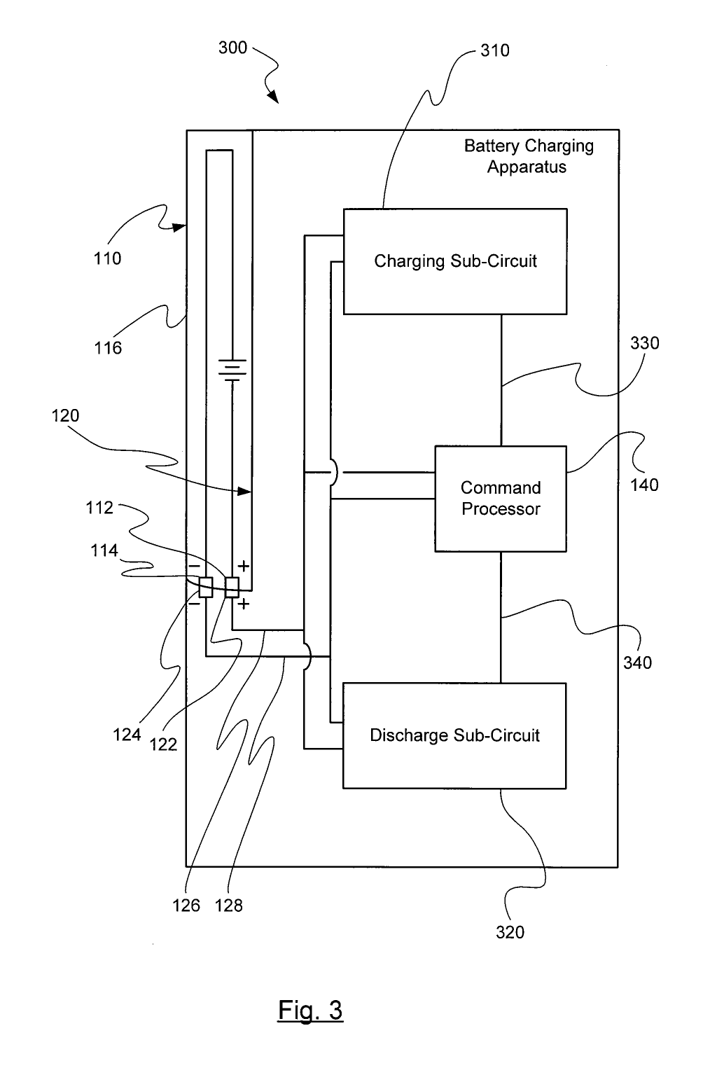

FIG. 3 is a block diagram, similar to the block diagram shown in FIG. 2, except showing a battery charging apparatus 300 where the functions of discharge circuit 130 are performed by a charging sub-circuit 310 and a discharge sub-circuit 320. In this embodiment, charging sub-circuit 310 may conduct charging operations on battery 110, for example slow and quick charging, while discharge sub-circuit 320 may conduct discharge operations. In some operations, such as conditioning and calibration operations, both charging sub-circuit 310 and discharge sub-circuit 320 may be used together, often sequentially, depending on the operation. Note also that in this embodiment, battery 110 is shown fully mechanically and electrically coupled with battery receptacle 120.

Communications from command processor 140 to charging sub-circuit 310 may be transmitted via communication connection 330. Communications from command processor 140 to discharge sub-circuit 320 may be transmitted via communication connection 340.

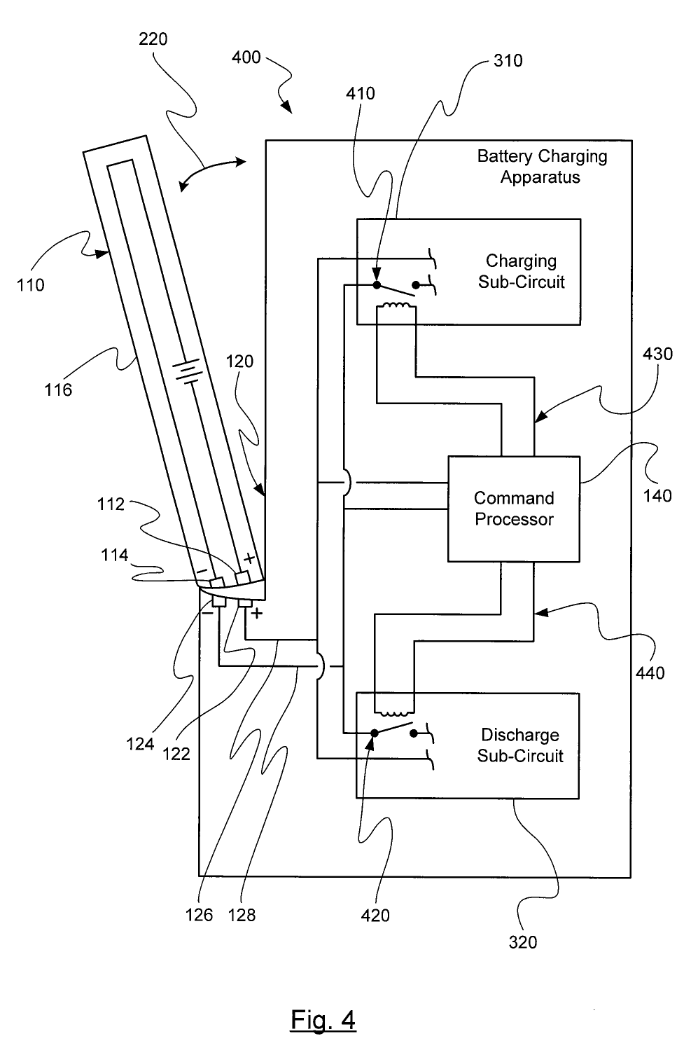

FIG. 4 is a block diagram, similar to the block diagram shown in FIG. 3, except showing a battery charging apparatus 400 with relay switches 410, 420 within the charging sub-circuit 310 and discharge sub-circuit 320 controlled by the command processor 140. In this embodiment, after command processor detects couplings, decouplings, and recouplings of battery 110 with battery receptacle 120, communications from command processor 140 to charging sub-circuit 310 and discharge sub-circuit 320 may occur in the form of relay switch energizing voltages via relay leads 430,440. These relays may, merely by way of example, be electrical relays or electronic solid-state relays.

In some embodiments, multiple relays may be used within charging circuit 130, charging sub-circuit 310, and/or discharge sub-circuit 320 to instruct the respective circuit to initiate a given operation. Other communication means, such as optical and/or wireless technologies may also, or instead, be used to communicate instructions from command processor 140 to charging circuit 130, charging sub-circuit 310, and/or discharge sub-circuit 320.

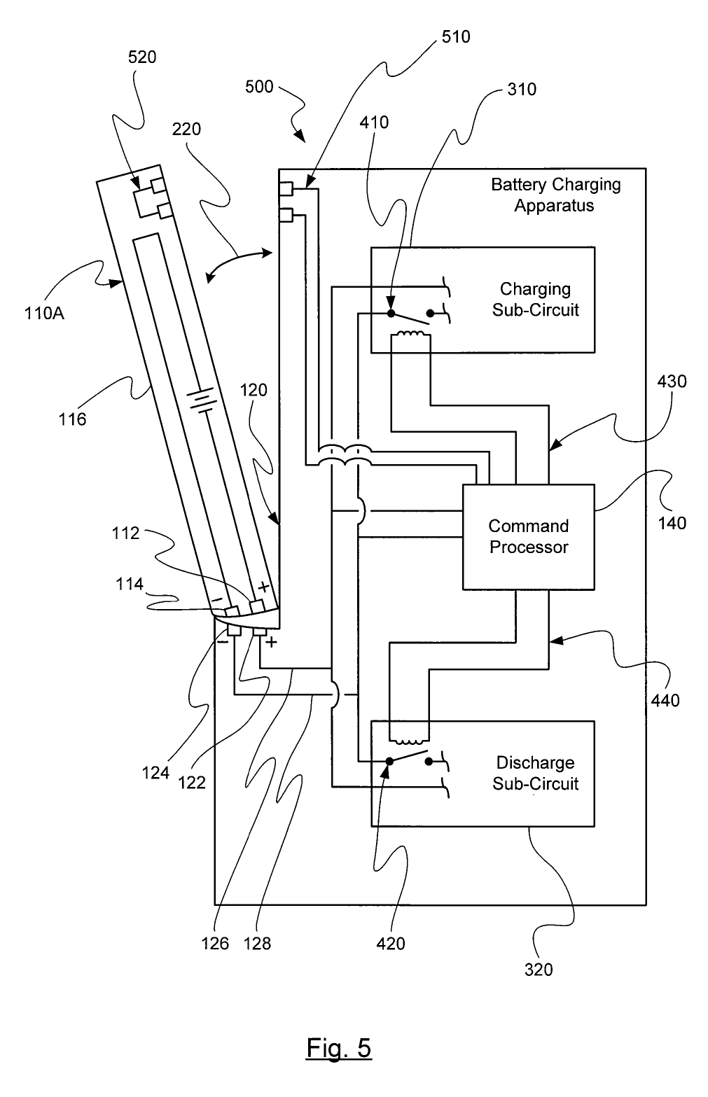

FIG. 5 is a block diagram, similar to the block diagram shown in FIG. 4, except showing a battery charging apparatus 500 having a separate electrical circuit 510 coupled with command processor 140 to detect mechanical coupling of battery 110A. In this embodiment, battery 110A has a short 520 which, once in contact with separate electrical circuit 510, closes separate electrical circuit 510. Command processor 140 monitors separate electrical circuit 510, thereby detecting when battery 110A is both electrically and fully mechanically coupled with battery receptacle 120.

In this embodiment, separate electrical circuit 510 may be used with, or instead of, contacts 122, 124 to detect the coupling status of battery 110A. Embodiments having separate electrical circuit 510 may be advantageous because separate electrical circuit 510 does not depend in any way on power being available within battery 110A. Any power for separate electrical circuit may be provided via command processor 140 instead. Embodiments using terminals 122, 124 to detect the coupling status of battery 110A may be more complex because batteries 110, whether charged or uncharged, may need to be detected, and the charge of the battery may necessary to power such detection.

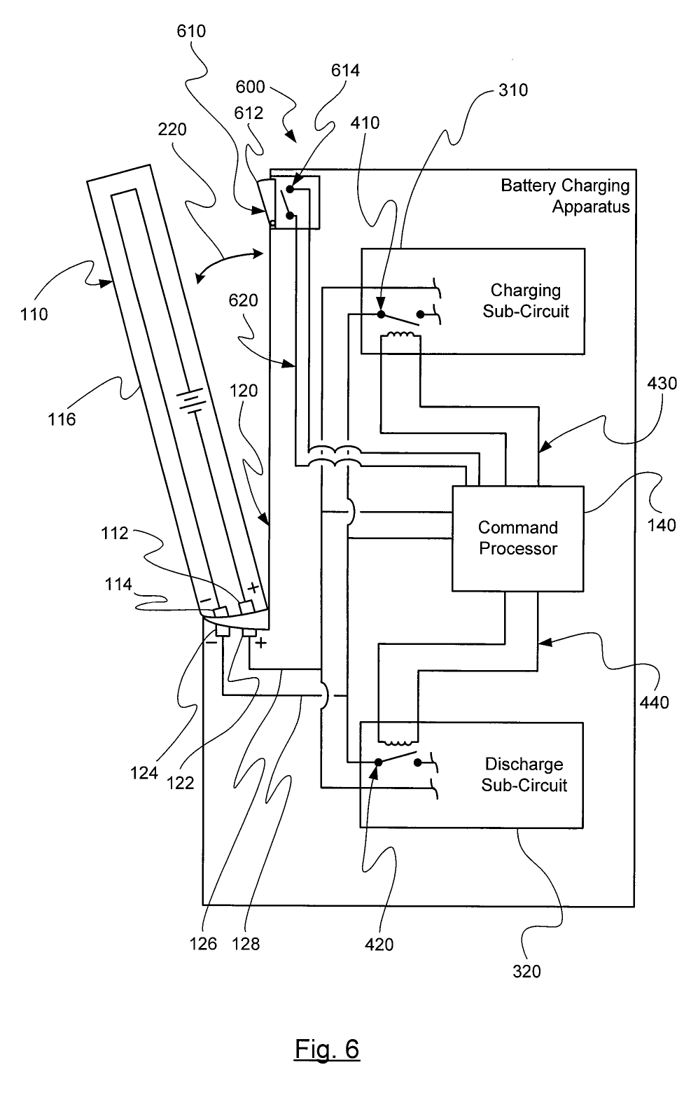

FIG. 6 is a block diagram, similar to the block diagram shown in FIG. 5, except showing a battery charging apparatus 600 having a mechanical switch 610 instead of the short-able separate electrical circuit 510 to detect mechanical coupling. This embodiment is similar to the one shown in FIG. 5. in that it closes a separate electrical circuit 620 to allow command processor 140 to detect the coupling status of battery 110.

When battery 110 is coupled with battery receptacle 120, casing 116 may impact mechanical lever 612, which will push closed electrical switch 614. When electrical switch 614 closes, separate electrical circuit 620 will be closed, allowing command processor 140 to detect the coupling status of battery 110. Embodiments using mechanical switch 610 to detect the coupling status of battery 110 may be advantageous because the detecting mechanism (in this embodiment mechanical switch 610), is located at the battery charging apparatus 600, rather than in battery 110 (as was short 520 in battery charging apparatus 500 shown in FIG. 5), with the battery 110 usually being the mobile, and more likely to be damaged, component of the system.

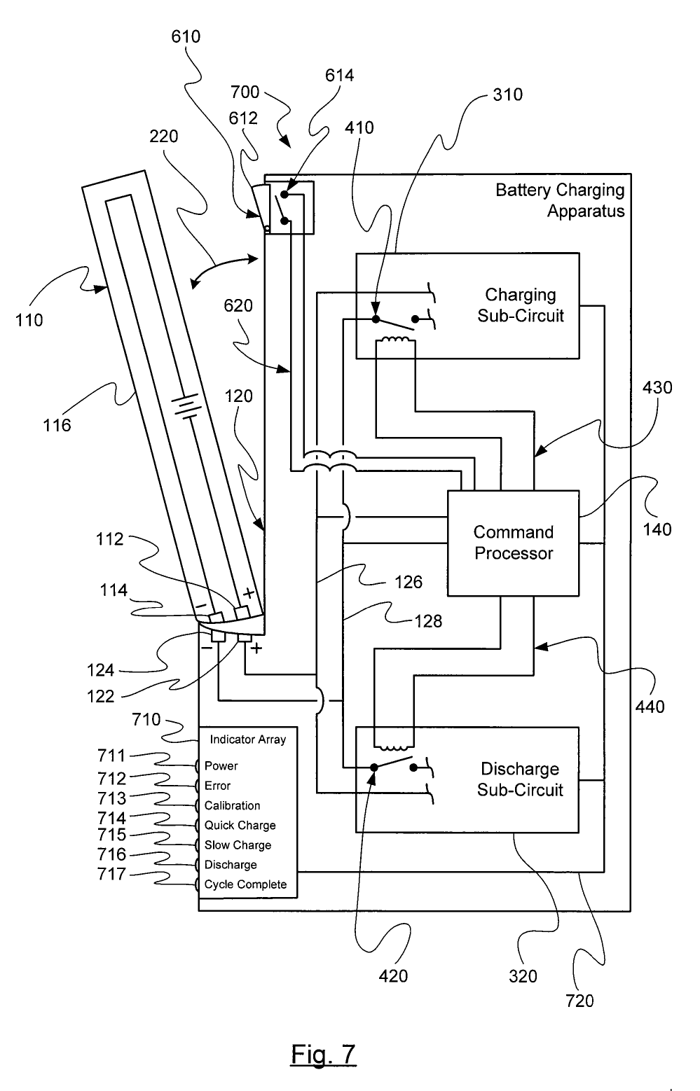

FIG. 7 is a block diagram, similar to the block diagram shown in FIG. 6, except showing a battery charging apparatus 700 except having an indicator array 710 to inform the user of battery charging apparatus 700 of information pertaining to battery charging apparatus 700 and/or battery 110. Merely by way of example, the indicator array may inform a user of either one or more of: the status of battery charging apparatus 700, the mode(s) that charging sub-circuit 310 and/or discharge sub-circuit 320 are operating in, the mode(s) that charging sub-circuit 310 and/or discharge sub-circuit 320 will be directed into if nothing further is done by user, the mode that mode(s) that that charging sub-circuit 310 and/or discharge sub-circuit 320 will be directed into if something in particular is done by the user.

Indicator array 700 may be coupled with one or more of command processor 140, charging sub-circuit 310, and discharge sub-circuit 320, possibly via communication connection 720. Indicator array 700 may inform a user of a status of the charger, such as with power light 711 or error light 712. Command processor may cause power light 711 to illuminate when battery charging apparatus has power and/or is operational, and illuminate error if there is a problem affecting normal operation, possibly a faulty battery 110.

Furthermore, indicator array 700 may inform a user of which mode battery charging apparatus 700 is operating in. Merely by way of example, FIG. 7 also shows indicator array 700 having a calibration light 713, a quick charge light 714, a slow charge light 715, a discharge light 716, and cycle complete light 717. In one embodiment, command processor 140 may illuminate one or more of lights 713, 714, 715, 716 to show the current operating mode. In another embodiment, one or more of lights 713, 714, 715, 716 may be illuminated to inform a user of which mode charging sub-circuit 310 and/or discharge sub-circuit 320 may be directed to operate in if the user takes no further action in decoupling and/or recoupling battery 110 to battery receptacle 120.

Any number of other communication schemes may also be implemented by command processor 140 and/or indicator array 710 to inform a user of the status of battery charging apparatus 700, current mode of battery charging apparatus 700, and/or the mode which will be activated by the command processor when and if battery 110 is decoupled and recoupled to battery receptacle 120. In one example, one light 713, 714, 715, 716 may be solidly lit when that is the current command to be communicated, but another light 713, 714, 715, 716 may blink to indicate to a user that such a mode will be commanded if battery 110 is decoupled and recoupled with battery receptacle 120. The blinking light 713, 714, 715, 716 may continue to blink for the particular time period during which a decoupling and consequent recoupling. Written instructions on the case of battery charging apparatus 700 may inform the user of the communication scheme employed by command processor 140 and indicator array 710.

In some embodiments, battery charging apparatus 700 may have a more dynamic visual or audio indicator such as a graphical screen and/or audio speaker to instruct the user of any of the above identified information. In any of the above or other schemes may thus inform the user of intelligent decisions made my command processor (those based on detecting characteristics of battery 110), and preset sequential mode schemes.

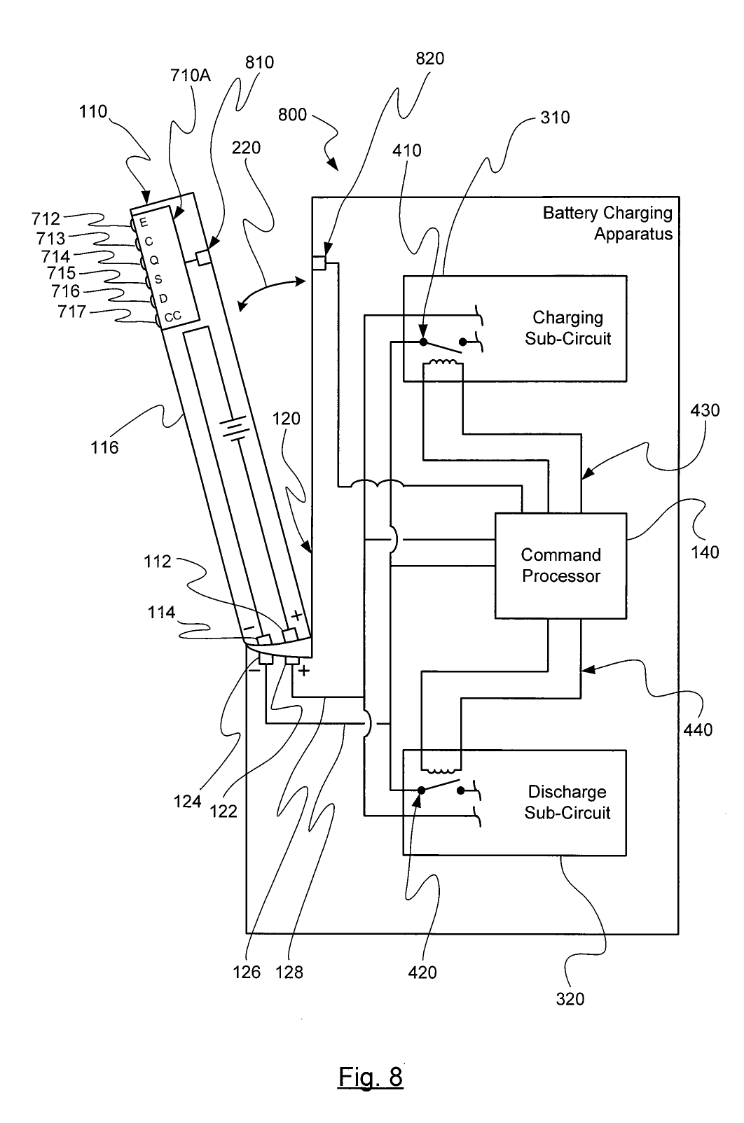

FIG. 8 is a block diagram, similar to the block diagram shown in FIG. 7, except showing a battery charging apparatus 800 and a battery 110B having an indicator array 710A on battery 110B instead of battery charging apparatus 800. In this embodiment, indicator lights 712, 713, 714, 715, 716, 717 in indicator array 710A may be incorporated with battery 110B, rather than battery charging apparatus 800. Indicator array 710A may be coupled with command processor 140 via communication connections 810 and 820. Otherwise indicator array 710A may operate substantially as indicator array 710 in FIG. 7.

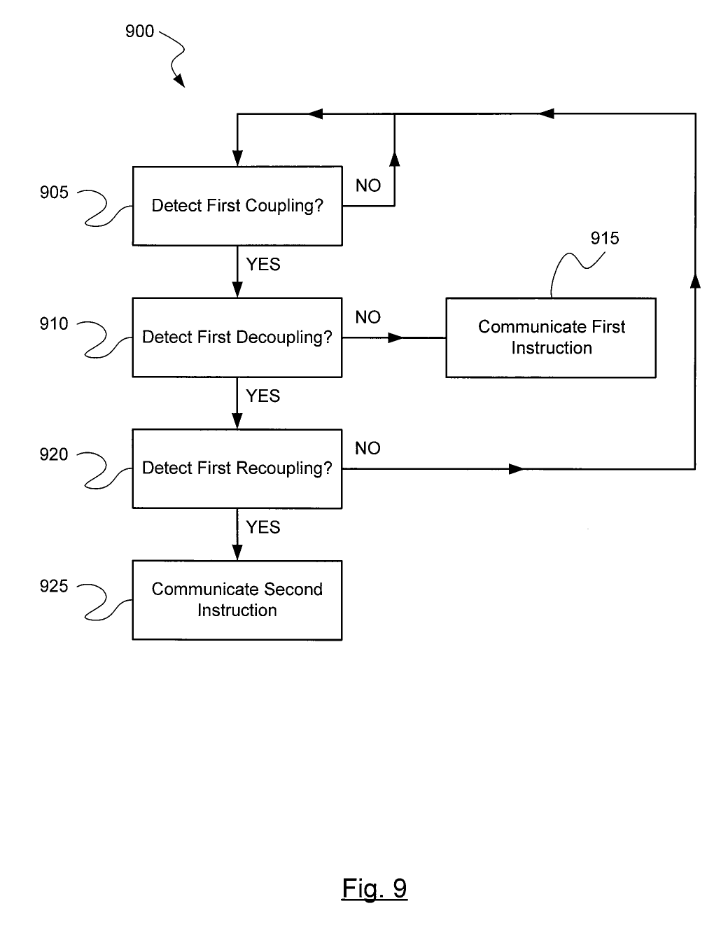

FIG. 9 is a flow diagram of a method 900 for communicating either of two possible instructions to an electrical apparatus. At block 905, the method may await detection of the first coupling of battery 110 with battery receptacle 120. Once the first coupling of battery 110 is detected, at block 910, the method may await detection of the first decoupling of battery 110 from battery receptacle 120. If no first decoupling is detected, then a first instruction may be communicated to battery charging circuit 130 at block 915. In some embodiments, the first instruction may be communicated to battery charging circuit 120 immediately, and remain in effect until a decoupling is detected. In other embodiments, the first instruction may not be communicated until a particular time period has passed since the first coupling.

Once the first decoupling is detected within a particular time period, at block 920 the detection of a first recoupling may be awaited. If no recoupling is detected within a particular time period, then the method may begin anew, awaiting a new “first” coupling a block 905. If a recoupling is detected within a particular time period, at block 925 a second instruction may be communicated to battery charging circuit 130.

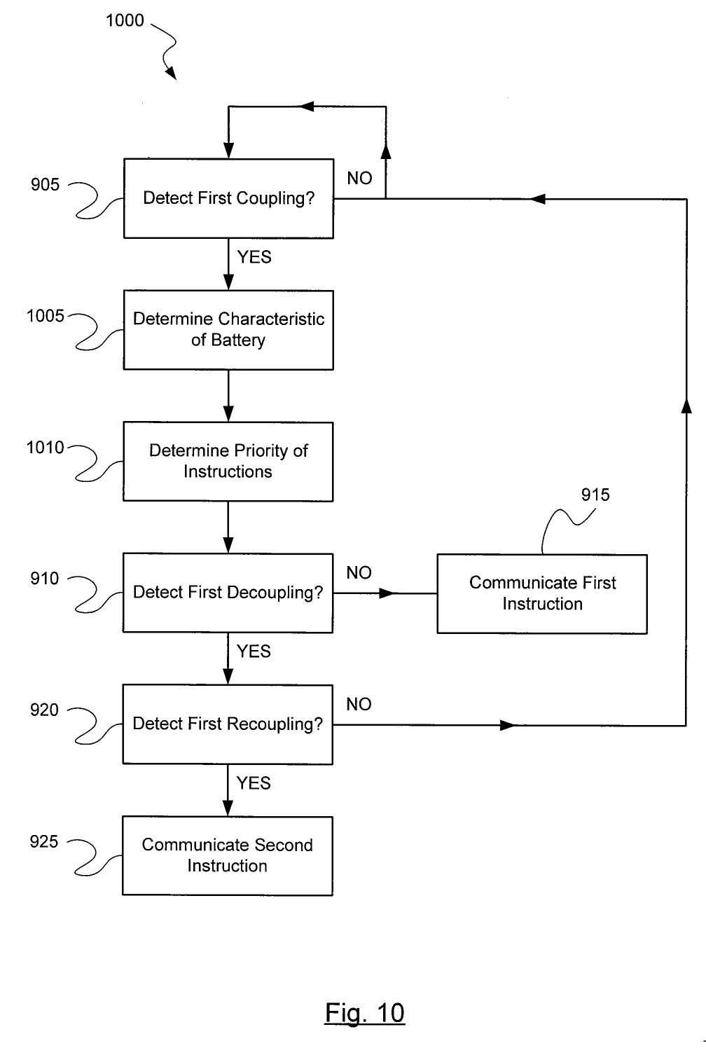

FIG. 10 is a flow diagram of a method 1000, similar to the method in FIG. 9, except which also uses determined characteristics of battery 110 to prioritize instructions. In this method, after detecting the first coupling at block 905, the method may determine at least one characteristic of battery 110. At block 1010, the method may determine the priority of the two possible instructions the method may communicate to battery charging circuit 130.

Merely by way of example, if, at block 1005, it is determined that the charge level of battery 110 is below a first certain threshold, but not below a second certain threshold, lower than the first, the method may, at block 1010 determine that a first instruction should be a slow charge mode instruction, while the second should be a quick charge mode instruction. In embodiments where characteristics of the battery are not determined, a preset sequence of instructions may determine the priority of instructions. In some embodiments, a user may be able to select whether the method or battery charging apparatus implementing the method acts in a “smart” or “dumb” mode, with “smart” mode automatically determining priority of instructions based on characteristic(s) of battery 110, or “dumb” mode where the priority of instructions is preset, independent of the characteristics of battery 110.

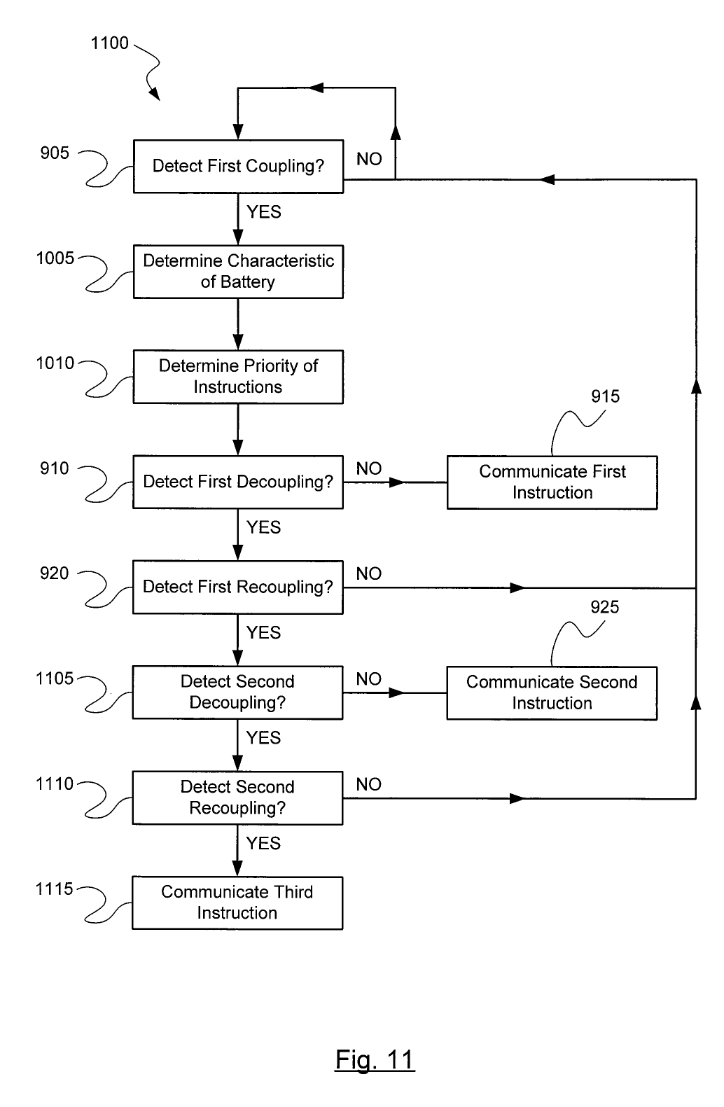

FIG. 11 is a flow diagram of a method 1100, similar to the method in FIG. 10, except also capable of communicating a third possible instruction. At block 1105, the detection of a second decoupling is awaited of a particular time period. If no second decoupling is detected, a second instruction may be communicated at block 925. If a second decoupling is detected, the method may await a second recoupling at block 1110 for a particular time period. If no recoupling is detected, the method may begin anew, awaiting a “first” coupling of battery 110 with battery receptacle 120 at block 905. If a recoupling is detected within a particular time period, a third communication may be communicated to battery charging circuit 130 at block 1115. Just as in FIG. 10, method 1100, at block 1010, may also prioritize each of the three instructions possibly communicated.

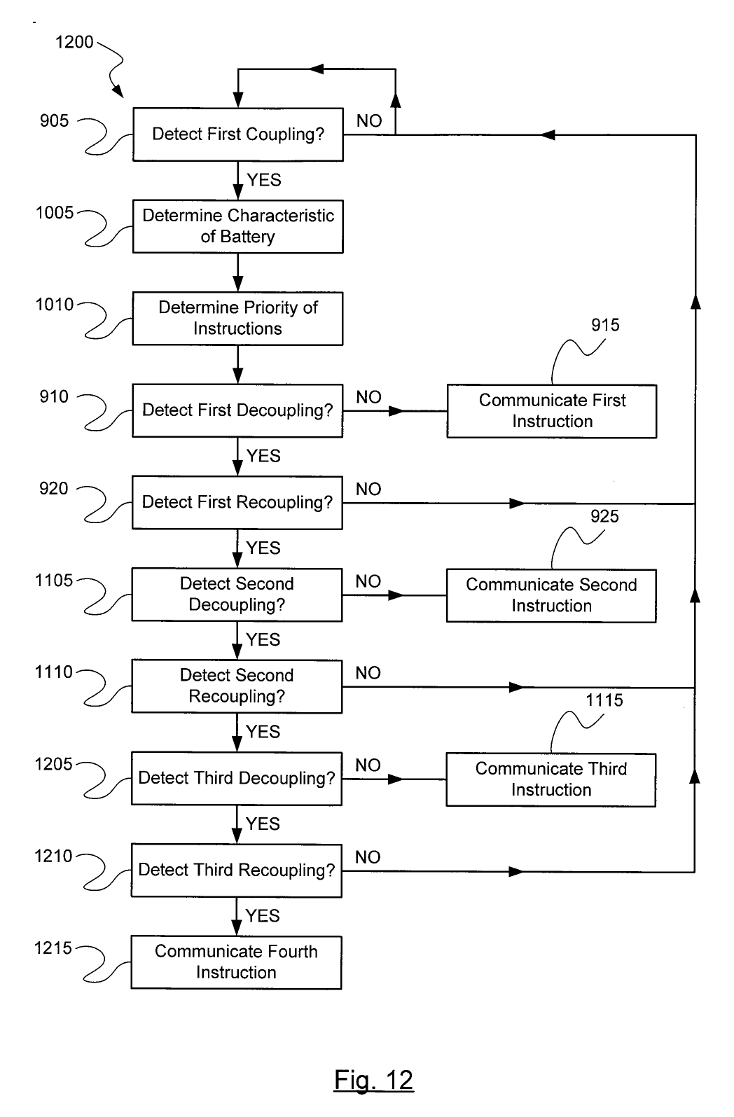

FIG. 12 is a flow diagram of a method 1200, similar to the method in FIG. 11, except also capable of communicating a fourth possible instruction. At block 1205, the detection of a third decoupling is awaited of a particular time period. If no third decoupling is detected, a third instruction may be communicated at block 1115. If a third decoupling is detected, the method may await a second recoupling at block 1210 for a particular time period. If no recoupling is detected, the method may begin anew, awaiting a “first” coupling of battery 110 with battery receptacle 120 at block 905. If a recoupling is detected within a particular time period, a fourth communication may be communicated to battery charging circuit 130 at block 1215. Just as in FIG. 10 and FIG. 11, method 1200, at block 1010, may also prioritize each of the four instructions possibly communicated. Those skilled in the art, upon reading the descriptions of these methods, will now recognize that any number of communications and/or instructions can be directed to be transmitted with additional decouplings and recouplings.

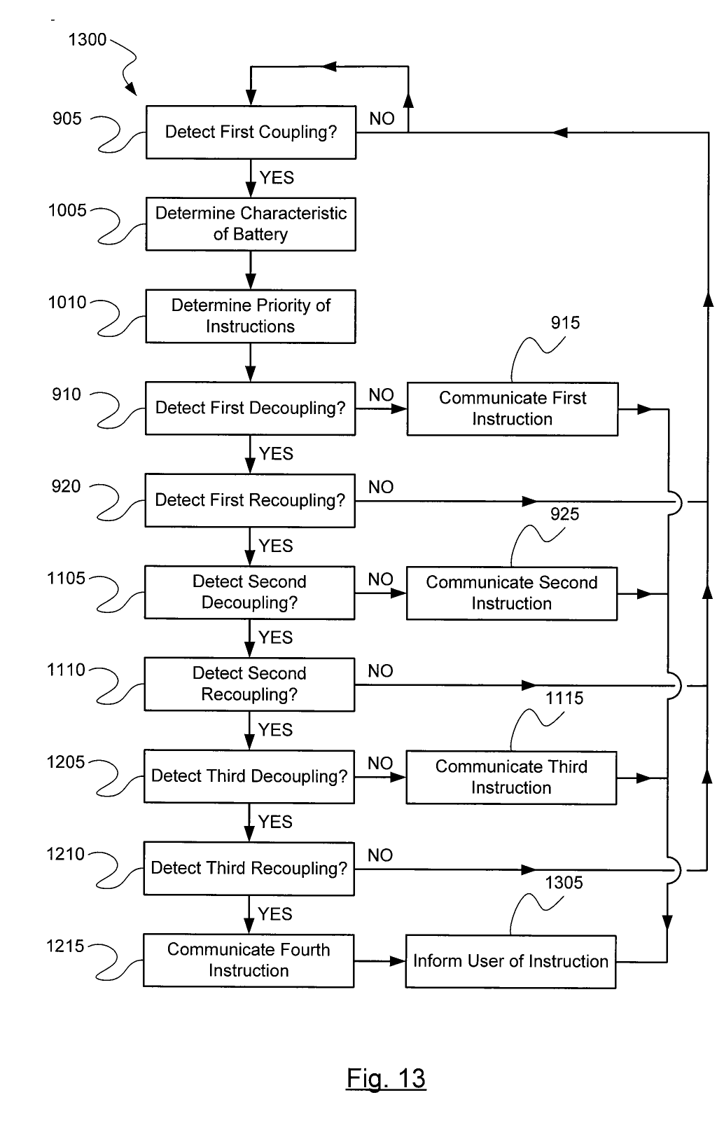

FIG. 13 is a flow diagram of a method 1300, similar to the method in FIG. 12, which also informs a user of which instruction is communicated. After instructions are communicated at block 915, block 925, block 1115, and block 1215, the method may inform a user of which instruction was communicated at block 1305. In other embodiments, as discussed above, the user may be informed at different points in the method of what the instructions will be communicated if different decoupling and recoupling decisions are made by the user.

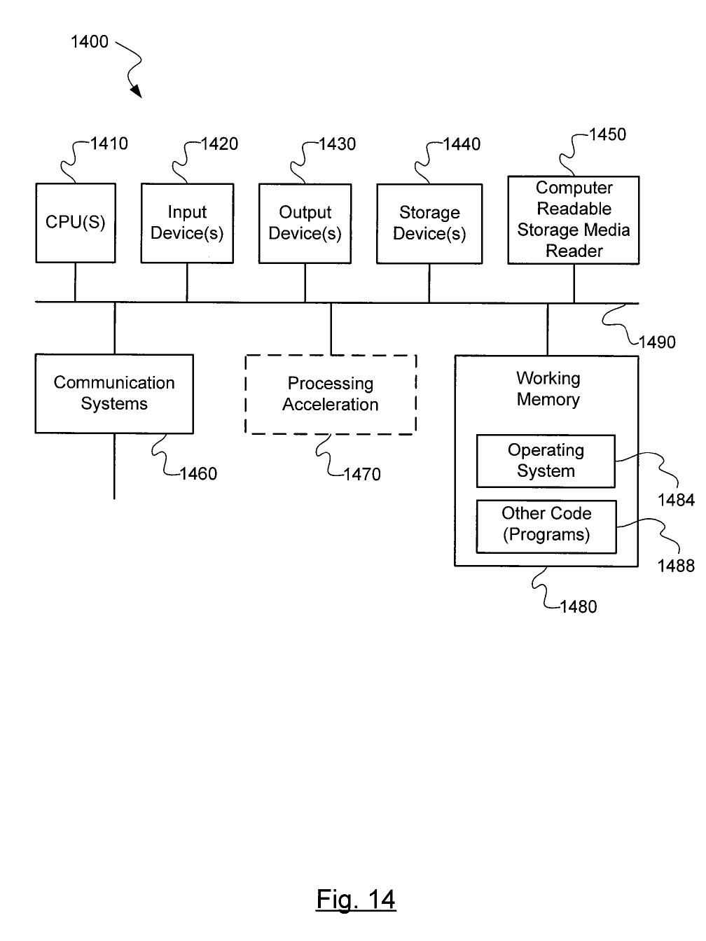

FIG. 14 is a block diagram illustrating an exemplary computer system in which embodiments of the present invention may be implemented. This example illustrates a computer system 1400 such as may be used, in whole, in part, or with various modifications, to provide the functions of charging circuit 130, charging sub-circuit 310, discharge sub-circuit 320, command processor 140, indicator array 710, and/or other components of the invention such as those discussed above. Merely by way of example, various functions of command processor 140 may be controlled by the computer system, for example, determining a characteristic of battery 110, communicating instructions to charging circuit 130, determining priority of instructions, etc.

The computer system 1400 is shown comprising hardware elements that may be electrically coupled via a bus 1490. The hardware elements may include one or more central processing units (CPUs) 1410, one or more input devices 1420 (e.g., a mouse, a keyboard, etc.), and one or more output devices 1430 (e.g., a display device, a printer, etc.). The computer system 1400 may also include one or more storage device 1440. By way of example, storage device(s) 1440 may be disk drives, optical storage devices, solid-state storage device such as a random access memory (“RAM”) and/or a read-only memory (“ROM”), which can be programmable, flash-updateable and/or the like.

The computer system 1400 may additionally include a computer-readable storage media reader 1450, a communications system 1460 (e.g., a modem, a network card (wireless or wired), an infra-red communication device, etc.), and working memory 1480, which may include RAM and ROM devices as described above. In some embodiments, the computer system 1400 may also include a processing acceleration unit 1470, which can include a DSP, a special-purpose processor and/or the like.

The computer-readable storage media reader 1450 can further be connected to a computer-readable storage medium, together (and, optionally, in combination with storage device(s) 1440) comprehensively representing remote, local, fixed, and/or removable storage devices plus storage media for temporarily and/or more permanently containing computer-readable information. The communications system 1460 may permit data to be exchanged with a network and/or any other computer described above with respect to the system 1400.

The computer system 1400 may also comprise software elements, shown as being currently located within a working memory 1480, including an operating system 1484 and/or other code 1488. It should be appreciated that alternate embodiments of a computer system 1400 may have numerous variations from that described above. For example, customized hardware might also be used and/or particular elements might be implemented in hardware, software (including portable software, such as applets), or both. Further, connection to other computing devices such as network input/output devices may be employed.

Software of computer system 1400 may include code 1488 for implementing any or all of the function of the various elements of the architecture as described herein. For example, software, stored on and/or executed by a computer system such as system 1400, can provide the functions of charging circuit 130, charging sub-circuit 310, discharge sub-circuit 320, command processor 140, indicator array 710, and/or other components of the invention. Methods implementable by software on some of these components have been discussed above in more detail.

A number of variations and modifications of the disclosed embodiments can also be used. For example, some of the embodiments discuss instructing discharge circuit 130 based on coupling, decoupling, and recoupling of battery 110 with battery receptacle 120, but other embodiments could instruct other functions of the battery charging apparatus, especially where the battery charging apparatus is an electronic device with purposes other than merely charging and conditioning batteries 110 (see devices discussed above). For example, functions of a radio communication device or a video recording device could be controlled by the methods and systems of the invention.

The invention has now been described in detail for the purposes of clarity and understanding. However, it will be appreciated that certain changes and modifications may be practiced within the scope of the appended claims.

What is claimed is:

1. A battery charging apparatus with a plurality of modes for charging a battery, the battery charging apparatus comprising:
a battery receptacle, wherein:
the battery receptacle is adapted to detachably and mechanically couple with the battery; and
the battery receptacle is adapted to detachably and electrically couple the battery with a battery charging circuit; and
a command processor, wherein:
the command processor is configured to detect a first at least partial mechanical coupling of the battery with the battery receptacle;
the command processor is further configured to detect a first at least partial mechanical decoupling of the battery from the battery receptacle;
the command processor is further configured to detect a first at least partial mechanical recoupling of the battery with the battery receptacle; and
the command processor is further configured to communicate a first instruction to the battery charging circuit based at least in part on detecting the first at least partial mechanical recoupling within a particular time period after the first at least partial mechanical decoupling.

2. The battery charging apparatus with the plurality of modes for charging the battery of claim 1, wherein the first instruction is based at least in part on an automatic determination of at least one characteristic of the battery.

3. The battery charging apparatus with the plurality of modes for charging the battery of claim 1, wherein the command processor is further configured to communicate a second instruction to the battery charging circuit based at least in part on detecting the first at least partial mechanical coupling, and wherein the second instruction is based at least in part on an automatic determination of at least one characteristic of the battery.

4. The battery charging apparatus with the plurality of modes for charging the battery of claim 1, wherein:
the command processor is further configured to detect a second at least partial mechanical decoupling of the battery from the battery receptacle;
the command processor is further configured to detect a second at least partial mechanical recoupling of the battery with the battery receptacle; and
the command processor is further configured to communicate a second instruction to the battery charging circuit based at least in part on detecting the second at least partial mechanical recoupling within a particular time period after the second at least partial mechanical decoupling.

5. The battery charging apparatus with the plurality of modes for charging the battery of claim 4, wherein:
the command processor is further configured to detect a third at least partial mechanical decoupling of the battery from the battery receptacle;
the command processor is further configured to detect a third at least partial mechanical recoupling of the battery with the battery receptacle; and
the command processor is further configured to communicate a third instruction to the battery charging circuit based at least in part on detecting the third at least partial mechanical recoupling of the battery within a particular time period after the third at least partial mechanical decoupling.

6. The battery charging apparatus with the plurality of modes for charging the battery of claim 1, wherein the particular time period after the first at least partial mechanical decoupling comprises a time period between a first point in time and a second point in time, and the first point in time is at the first at least partial mechanical decoupling.

7. The battery charging apparatus with the plurality of modes for charging the battery of claim 1, wherein the particular time period after the first at least partial mechanical decoupling comprises a time period between a first point in time and a second point in time, and the first point in time is a certain time after the first at least partial mechanical decoupling.

8. The battery charging apparatus with the plurality of modes for charging the battery of claim 1, wherein the battery charging apparatus further comprises an indicator configured to inform a user of a last instruction communicated to the battery charging circuit.

9. The battery charging apparatus with the plurality of modes for charging the battery of claim 1, wherein the charging circuit is configured to operate in a plurality of modes, and wherein the plurality of modes are selected from the group consisting of a calibration mode, a quick charging mode, a slow charging mode, and a discharge mode.

10. The battery charging apparatus with the plurality of modes for charging the battery of claim 1, wherein the first instruction comprises a mode instruction directing the battery charging circuit to operate in at least one of a plurality of modes.

11. A method for communicating one or more instructions to an electrical apparatus with a battery receptacle, the method comprising:
detecting a first at least partial mechanical coupling of a battery with the battery receptacle;
detecting a first at least partial mechanical decoupling of the battery from the battery receptacle;
detecting a first at least partial mechanical recoupling of the battery with the battery receptacle; and
communicating a first instruction to the electrical apparatus based at least in part on detecting the first at least partial mechanical recoupling within a particular time period after the first at least partial mechanical decoupling.

12. The method for communicating one or more instructions to the electrical apparatus with the battery receptacle of claim 11, the method further comprising determining at least one characteristic of the battery, wherein the first instruction is based at least in part on the at least one characteristic of the battery.

13. The method for communicating one or more instructions to the electrical apparatus with the battery receptacle of claim 11, the method further comprising:
determining at least one characteristic of the battery;
communicating a second instruction to the electrical apparatus based at least in part on detecting the first at least partial mechanical coupling, wherein the second instruction is based at least in part on an automatic determination of characteristics of the battery.

14. The method for communicating one or more instructions to the electrical apparatus with the battery receptacle of claim 11, the method further comprising:
detecting a second at least partial mechanical decoupling of the battery from the battery receptacle;
detecting a second at least partial mechanical recoupling of the battery with the battery receptacle; and
communicating a second instruction to the electrical apparatus based at least in part on detecting the second at least partial mechanical recoupling within a particular time period after the second at least partial mechanical decoupling.

15. The method for communicating one or more instructions to the electrical apparatus with the battery receptacle of claim 14, the method further comprising:
detecting a third at least partial mechanical decoupling of the battery from the battery receptacle;
detecting a third at least partial mechanical recoupling of the battery with the battery receptacle; and
communicating a third instruction to the electrical apparatus based at least in part on detecting the third at least partial mechanical recoupling within a particular time period after the third at least partial mechanical decoupling.

16. The method for communicating one or more instructions to the electrical apparatus with the battery receptacle of claim 11, the method further comprising informing a user of a last instruction communicated to the electrical apparatus.

17. A machine-readable medium having machine-executable instructions configured to perform the machine-implementable method for communicating one or more instructions to an electrical apparatus with a battery receptacle of claim 11.

18. A machine adapted to perform the machine-implementable method for communicating one or more instructions to an electrical apparatus with a battery receptacle of claim 11.

19. An electrical apparatus with a battery receptacle, the electrical apparatus comprising:
a battery receptacle, wherein:
the battery receptacle is adapted to detachably and mechanically couple with the battery; and
the battery receptacle is adapted to detachably and electrically couple the battery with the electrical apparatus; and
a command processor, wherein:
the command processor is configured to detect a first at least partial mechanical coupling of the battery with the battery receptacle;
the command processor is further configured to detect a first at least partial mechanical decoupling of the battery from the battery receptacle;
the command processor is further configured to detect a first at least partial mechanical recoupling of the battery with the battery receptacle; and
the command processor is further configured to communicate a first instruction to the electrical apparatus based at least in part on detecting the first at least partial mechanical recoupling within a particular time period after the first at least partial mechanical decoupling.

20. The electrical apparatus with a battery receptacle of claim 19, wherein the first instruction comprises a mode instruction directing the electrical apparatus to operate in at least one of a plurality of modes.
